(19) United States
(12) Patent Application Publication
(10) Pub. No.: US 2026/0037878 A1
(43) Pub. Date: Feb. 5, 2026

(54) COMPUTING SYSTEMS AND METHODS FOR RARE EVENT PREDICTION

(71) Applicant: The Toronto-Dominion Bank, Toronto (CA)

(72) Inventors: Keyvan GOLESTAN IRANI, Aurora (CA); Maksims VOLKOVS, Toronto (CA); Tongzi WU, Toronto (CA); Chenzi QIE, Toronto (CA)

(21) Appl. No.: 18/790,347

(22) Filed: Jul. 31, 2024

(51) Int. Cl. G06N 20/20

(52) U.S. Cl. CPC G06N 20/20

(57) ABSTRACT

Systems and methods for performing rare event prediction using artificial intelligence. The method includes training a primary prediction model, such as XGBoost, using a first training dataset; using the trained primary prediction model to generate a primary prediction score for a rare event for each data point in a second training dataset; generating a modified second training dataset by selecting k data points of the second training dataset with a highest primary prediction score to form the modified second training dataset and adding the corresponding primary prediction score to each of the k data points of the modified second training dataset as a feature, wherein k is an integer greater than one; training a secondary prediction model using the modified second training dataset; and forming a multi-stage rare event prediction system from the trained primary prediction model and the trained secondary prediction model.

### TECHNICAL FIELD

The disclosed example embodiments relate to computer-implemented methods and systems for rare event prediction, and more specifically rare event prediction using machine learning.

### BACKGROUND

Event prediction is the process of predicting the likelihood of a particular event occurring in the future based on historical data. Being able to predict future events is beneficial in many fields such as, but not limited to, transportation, healthcare, manufacturing, telecommunication, energy and natural disasters.

Event prediction may be performed using a model, which may be referred to herein as a prediction model, which is designed to receive a set of features related to historical events and determine from the set of features the likelihood that a particular event will occur in the future, and, in some cases, within a particular window in the future. A prediction model typically includes a machine learning algorithm or component which is trained (e.g., the parameters (e.g., weights and biases) of the prediction model are selected) to determine the likelihood that a particular event will occur in the future from a set of features representing historical events using a training data set. The training dataset comprises a plurality of example data points wherein each data point comprises a set of input parameters representing a set of historical events and an indication of whether the particular event occurred subsequent to the historical events (e.g., within a predetermined window after the historical events). The data points in the training dataset generally represent real-world historical examples.

Accordingly, a prediction model learns, from the training dataset, the relation between features of historical events and a future event. The trained prediction model can then be used to predict the likelihood of the particular event occurring in the future (e.g., within a predetermined window after the historical events) from a set of parameters representing a new set of historical events.

### SUMMARY

The following summary is intended to introduce the reader to various aspects of the detailed description, but not to define or delimit any invention.

A first aspect provides a system for performing rare event prediction, the system comprising: a memory, a communication interface, and at least one processor operatively coupled to the memory and the communication interface; the at least one processor configured to: train a primary prediction model using a first training dataset to generate a trained primary prediction model; use the trained primary prediction model to generate a primary prediction score for a rare event for each data point in a second training dataset; generate a modified second training dataset by selecting k data points of the second training dataset with a highest primary prediction score to form the modified second training dataset and adding the corresponding primary prediction score to each of the k data points of the modified second training dataset as a feature, wherein k is an integer greater than one; train a secondary prediction model using the modified second training dataset to generate a trained secondary prediction model; and form a multi-stage rare event prediction system from the trained primary prediction model and the trained secondary prediction model.

The at least one processor may be configured to, prior to using the trained primary prediction model to generate the primary prediction score for each data point in the second training dataset, fine-tune the trained primary prediction model using the second training dataset.

The at least one processor may be configured to fine-tune the trained primary prediction model so that the trained primary prediction model has an optimized recall metric with respect to the second training dataset.

The least one processor may be configured to fine-tune the trained primary prediction model so that the trained primary prediction model has an optimized recall at k metric with respect to the second training dataset.

The at least one processor may be configured to, prior forming the multi-stage rare event prediction system: use the trained primary prediction model to generate a primary prediction score for the rare event for each data point in a validation dataset; and fine-tune the trained secondary prediction model using the validation dataset and the primary prediction scores for the data points in the validation dataset.

The at least one processor may be configured to fine-tune the trained secondary prediction model so that the trained secondary predication model has an optimized area under a receiver operating characteristics curve metric and/or a precision at k metric.

The at least one processor may be configured to: use the trained primary prediction model to generate a primary prediction score for the rare event for each data point in a test dataset; use the trained secondary prediction model to generate a secondary prediction score for the rare event for each data point in the test dataset in combination with the corresponding primary prediction score; and evaluate a performance of the multi-stage rare even prediction system based on the secondary prediction scores.

Each data point may comprise a set of features representing a set of events in a first time period and an indication of whether the rare event occurred during a second, subsequent, time period.

There may be a time buffer between the first time period and the second, subsequent, time period.

The multi-stage rare event prediction system may be configured to: receive a set of features representing a set of historical events and use the primary trained prediction model to generate a primary prediction score for the set of features; and use the trained secondary prediction model to generate a secondary prediction score for the set of features in combination with the primary prediction score.

The at least one processor may be configured to use the multi-stage rare event prediction system to generate a prediction score for the rare event for a new set of features representing a new set of historical events.

The least one processor may be configured to compare the prediction score for the rare event for the new set of features to a predetermined threshold, and in response to determining the prediction score exceeds the predetermined threshold, take an action.

The at least processor may be configured to: use the trained primary prediction model to generate a primary prediction score for the rare event for each data point in a third training dataset; use the training secondary prediction model to generate a secondary prediction score for the rare event for each data point in the third training dataset in combination with the corresponding primary prediction score; generate a modified third training dataset by selecting k data points of the third training dataset with a highest primary prediction score to form the modified third training dataset and adding the corresponding secondary prediction score to each of the k data points of the modified third training dataset as a feature; and train a tertiary prediction model using the modified third training dataset to generate a trained tertiary prediction model; wherein the multi-stage rare event prediction system is also formed from the trained tertiary prediction model.

The first training dataset may be an imbalanced dataset.

A second aspect provides a method for performing rare event prediction, the method executed in a computing environment comprising one or more processors, a communication interface, and memory, and the method comprising: training a primary prediction model using a first training dataset to generate a trained primary prediction model; using the trained primary prediction model to generate a primary prediction score for a rare event for each data point in a second training dataset; generating a modified second training dataset by selecting k data points of the second training dataset with a highest primary prediction score to form the modified second training dataset and adding the corresponding primary prediction score to each of the k data points of the modified second training dataset as a feature, wherein k is an integer greater than one; training a secondary prediction model using the modified second training dataset to generate a trained secondary prediction model; and forming a multi-stage rare event prediction system from the trained primary prediction model and the trained secondary prediction model.

The method may further comprise, prior to using the trained primary prediction model to generate the primary prediction score for each data point in the second training dataset, fine-tuning the trained primary prediction model using the second training dataset.

The method may further comprise, prior forming the multi-stage rare event prediction system: using the trained primary prediction model to generate a primary prediction score for the rare event for each data point in a validation dataset; and fine-tuning the trained secondary prediction model using the validation dataset and the primary prediction scores for the data points in the validation dataset.

Each data point may comprise a set of features representing a set of events in a first time period and an indication of whether the rare event occurred during a second, subsequent, time period.

The multi-stage rare event prediction system may be configured to: receive a set of features representing a set of historical events and use the primary trained prediction model to generate a primary prediction score for the set of features; and use the trained secondary prediction model to generate a secondary prediction score for the set of features in combination with the primary prediction score.

A third aspect provides a non-transitory computer readable medium storing computer executable instructions which, when executed by at least one computer processor, cause the at least one computer processor to carry out a method for performing rare event prediction, the method comprising training a primary prediction model using a first training dataset to generate a trained primary prediction model; using the trained primary prediction model to generate a primary prediction score for a rare event for each data point in a second training dataset; generating a modified second training dataset by selecting k data points of the second training dataset with a highest primary prediction score to form the modified second training dataset and adding the corresponding primary prediction score to each of the k data points of the modified second training dataset as a feature, wherein k is an integer greater than one; training a secondary prediction model using the modified second training dataset to generate a trained secondary prediction model; and forming a multi-stage rare event prediction system from the trained primary prediction model and the trained secondary prediction model.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a block diagram of an example system for rare event prediction;

FIG. 2 is a block diagram of the cloud-based computing device of FIG. 1 configured to perform rare event prediction using a multi-stage rare event prediction system;

FIG. 3 is a schematic diagram of an example data point for training a multi-stage rare event prediction system;

FIG. 4 is a schematic diagram of an example set of data points within an example time window for training a multi-stage rare event prediction system;

FIG. 5 is a schematic diagram of an example split of data points between training datasets and test datasets;

FIG. 6 is a block diagram of an example computer;

FIG. 7 is a flow diagram of an example method for generating a multi-stage rare event prediction system; and

FIG. 8 is a flow diagram of an example method for using a multi-stage rare event prediction system to predict the rare event from a set of features representing a set of historical events.

### DETAILED DESCRIPTION

As described above, a prediction model is generally trained (e.g., the parameters (e.g., weights and biases) of the prediction model are selected) to determine the likelihood that a particular event will occur in the future (e.g., generate a prediction score) from a set of features representing a set of historical events using a training data set which comprises a plurality of example data points. Each example data point comprises a set of features representing historical events and an indication of whether the particular event occurred subsequent to the historical events (e.g., within a predetermined window after the historical events).

However, in some cases, the training dataset is imbalanced. A dataset is said to be imbalanced if a large portion of the data points have one outcome with respect to the particular event (e.g., a negative outcome—i.e., the event did not occur) and only a small portion of the data points have the opposite outcome with respect to the particular event (e.g., a positive outcome—i.e., the event did occur). An imbalanced dataset often occurs when the event that is being predicted is a rare event—i.e., an event that occurs infrequently or has a significantly low prevalence within a specific population, geographic area or time frame. In some cases, if the rate of occurrence of the event is less than 5%, it may be considered a rare event. Examples of rare events include, but are not limited to, certain medical diseases (e.g., rare forms of cancer), nature disasters, and fraud in financial transactions. Predicting a rare event is akin to finding a needle in a haystack. Accurate rare event prediction using prediction models has proven to be a difficult to achieve.

Specifically, when a prediction model is trained on a highly imbalanced training dataset (e.g., to predict a rare event) a significant portion of the prediction model capacity is wasted identifying easy negative patterns. An easy-negative pattern is a set of parameters representing historical data which the prediction model confidently predicts that that the future event will not occur—i.e., the prediction model outputs a low prediction score.

Accordingly, described herein is multi-stage rare event prediction system comprising a primary stage followed by one or more secondary stages. The primary stage comprises a primary prediction model that is configured to receive a set of features that represent a set of historical events and generate a primary prediction score that indicates, based on the set of features, the likelihood that a rare event will occur. Each secondary stage comprises a secondary prediction model that (i) receives the set of features that represent the set of historical events and a prediction score that was generated by the prediction model in the previous stage and (ii) generates a secondary prediction score that indicates, based on the set of historical events and the predication score, the likelihood that the future event will occur. The secondary prediction score generated by the secondary prediction model in the final stage can then be used as the final prediction score for the set of features. The primary prediction model is trained on an imbalanced training dataset. In contrast, each secondary prediction model is trained on the data points in a different training dataset which have the highest prediction scores according to the prediction model in the previous stage. In other words, the secondary prediction model(s) are trained on a dataset in which the easy negatives have been removed. The described multi-stage event prediction system allows the secondary prediction model(s) to focus on learning complex patterns of the hard negatives and the positive data points.

Specifically, in the methods described herein, a primary prediction model is trained using an imbalanced training dataset; the trained primary prediction model is used to generate a primary prediction score for each data point in a second training dataset; a modified second training dataset is generated which comprises the data points in the second training dataset that have the highest primary prediction scores and each data point in the modified second training dataset is augmented with the corresponding primary prediction score as an additional feature; and the secondary prediction model is trained using the modified second training dataset. A prediction score can then be generated for a new set of features by using the trained primary prediction model to generate a primary prediction score based on the new set of features; and using the trained secondary prediction model to generate a secondary prediction score based on the new set of features and the primary prediction score for the new set of features.

In some of the examples described below, the multi-stage rare event prediction system is configured to determine the probability that a debit card will be compromised in the future—i.e., used in a fraudulent transaction. Predicting fraudulent transaction may help ensure the security of debit card transactions and/or reduce financial losses. However, this is an example only, and the multi-stage rare event prediction systems and methods described herein may be used for predicting any type of rare events, such as, but not limited to, medical diagnosis and natural disaster prediction.

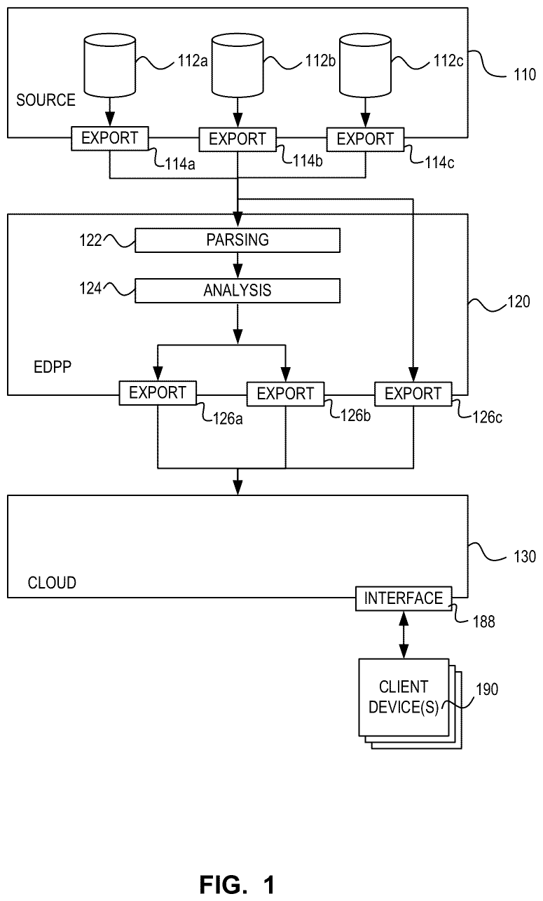

Reference is now made to FIG. 1, which illustrates a block diagram of an example computing system 100, in accordance with at least some embodiments. Computing system 100 comprises a source database system 110, an enterprise data provisioning platform (EDPP) 120 operatively coupled to the source database system 110, and a cloud-based computing cluster 130 that is operatively coupled to the EDPP 120. In some cases, this computing system 100 is provided for performing rare event prediction.

Source database system 110 has one or more databases, of which three are shown for illustrative purposes: database 112a, database 112b and database 112c. One or more of the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

The EDPP 120 receives source data exported by the export modules 114a, 114b, 114c of the source database system 110, processes it and exports the processed data to an application database within the cloud-based computing cluster 130. For example, a parsing module 122 of the EDPP 120 may perform extract, transform and load (ETL) operations on the received source data.

In many environments, access to the EDPP 120 may be restricted to relatively few users, such as administrative users. However, with appropriate access permissions, data relevant to a document or group of documents (e.g., a client document) may be exported via the reporting and analysis module 124 or an export module 126a, 126b, 126c. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of the EDPP 120 may “de-risk” data tables that contain confidential data prior to transmission to the cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 188, which facilitates data communication with one or more client devices 190.

In some environments, the EDPP may be omitted.

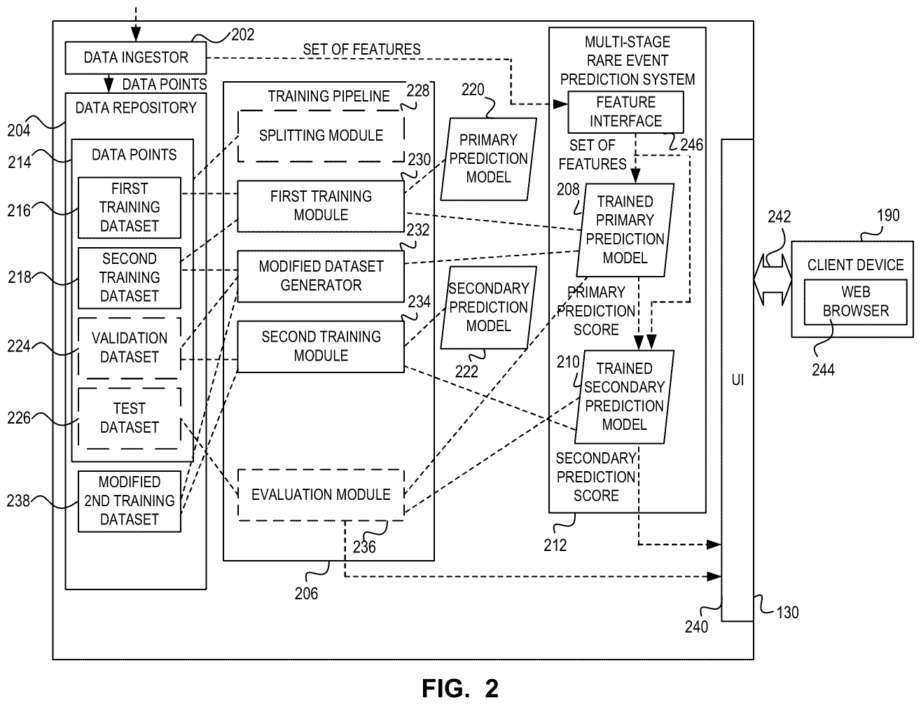

Reference is now made to FIG. 2, which illustrates an example implementation of the cloud-based computing cluster 130 of FIG. 1.

The example cloud-based computing cluster 130 includes a data ingestor 202, a data repository 204, and a training pipeline 206 for generating trained prediction models 208, 210 to form part of a multi-stage rare event prediction system 212. In some cases, one or more of the components of the cloud-based computing cluster 130 may be implemented by one or more computers within the cloud-based computing cluster. In some cases, one or more of these components may be implemented as virtual machines within the cloud-based computing cluster.

The data ingestor 202 is configured to receive from, for example, the EDPP 120, a plurality of data points 214 and store the received data points 214 in the data repository 204. The data points 214 are designed to be used to train a prediction model to predict, from a set of features that represent a set of historical events, the likelihood that a rare event will occur in the future. Each data point 214 comprises a set of features that represent a set of historical events and information indicating whether the particular event occurred after the historical events (i.e., information indicating a positive outcome if the particular event occurred, and information indicating a negative outcome if the particular event did not occur). The data points 214 may be generated from real historical data. For example, the source database system 110 may store real historical data for a period of time and the EDPP 120 may process the stored historical data to generate data points therefrom. The historical events and the features that are used to represent those historical events will depend on the type of rare event that is to be predicted and the data available.

For example, where the multi-stage rare event prediction system is to predict that a debit card will be compromised in the future—i.e., that the debit card will be used in a fraudulent transaction—the set of historical events may comprise transactions and related data for a debit card and the features that are used to represent those transactions may include features in one or more of the following categories: merchant categories, profile, transactions, and merchants. Features in the merchant category may comprise information about different categories. For example, features in the merchant category may comprise a count of the number of transactions and total transaction amounts for a plurality of different merchant categories such as, but not limited to, online services, restaurants and clothing categories. Features in the profile category may comprise feature that describe the debit card owner, such as their age, account status and account holding balance. Features in the transactions category may provide transactional information such as, but not limited to, the number of early transactions, the number of card-on-file POS, card provisioning, and an e-commerce indication. Features in the merchant category may provide information about the merchants the transactions relate. For example, features in the merchant category may include, for each different merchant in the relevant transaction history, features that describe transaction volume trends, fraud profile and approval rate for that merchant.

The received data points 214 are imbalanced—specifically there are significantly more data points that have a negative outcome (i.e., the future event did not occur) than data points that have a positive outcome (i.e., the future event did occur).

In some cases, each data point 214 may comprise features related to historical events that occurred in a specific time period or window (e.g., 8-week window), which may be referred to herein as the feature window. In these cases, the set of features in a data point 214 are generated from events that occurred within that feature window (e.g., 8-week window). In some cases, each data point may indicate a positive outcome if the particular event occurred within a specific time period or window (e.g., 1 week) after the feature window, which may be referred to as the target window. In some cases, there may be delays from collecting data related to a set of events to when a feature set representing that set of events can be presented to the 2-stage rare event prediction system for prediction. For example, if data is collected on a weekly basis and it takes a week for features representing events in a particular week to be available to the multi-stage rare event prediction system 212, this may mean that to predict whether an event will occur within the next week (target window) one cannot rely on features representing the events in the most recent 8 weeks (feature window) since the features representing the events in the most recent week are not yet available. Accordingly, the prediction is made based on the features representing the events in the 8 weeks preceding the most recent week. To accommodate this delay, in each data point, there may be a buffer (1 week in this example) between the feature window and the target window.

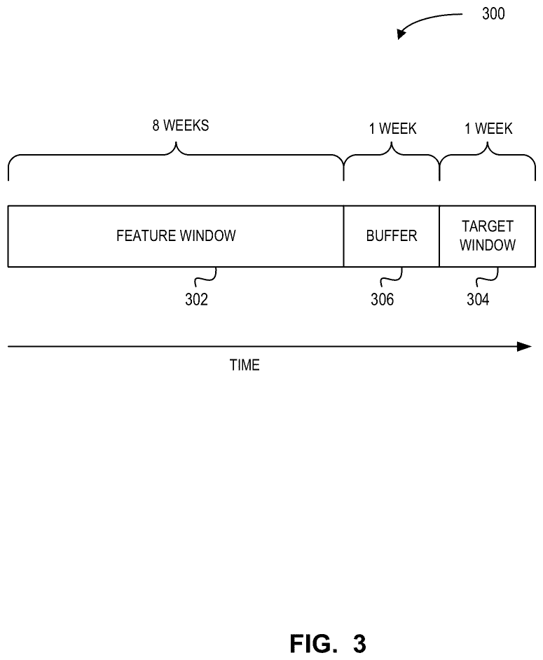

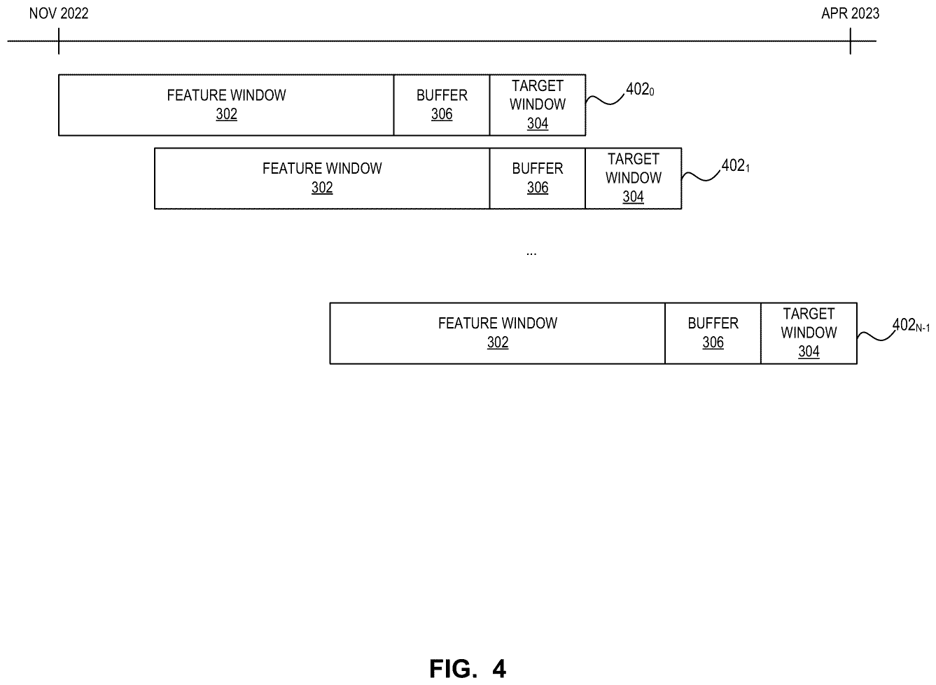

For example, FIG. 3 shows an example data point 300 for a rare event prediction system that is configured to predict that a debit card will be compromised in the future—i.e., that the debit card will be used in a fraudulent transaction—wherein debit card data is collected on a weekly basis and the features representing the events in a particular week is available one week later. In the example shown in FIG. 3, the feature window 302 is 8 weeks, the target window 304 is one week and there is a one-week buffer 306 between the feature window 302 and the target window 304. In this example, each data point comprises features that represent debit card transactions/data within an 8-week window. If a fraud transaction occurred on that debit card, not within the week immediately following the 8-week window, but the week after that, the data point is identified as having a positive outcome. Otherwise, the data point is identified as having a negative outcome. However, it will be evident that this is an example only, and that in other examples other sized feature windows, target windows and/or buffers may be used.

Where the data points 214 are configured as shown in the example of FIG. 3, then, as shown in FIG. 4, there may be a plurality of data points 402₀, 402₁, . . . 402_{N-1} per debit card. Specifically, there may be one data point 402₀, 402₁, . . . 402_{N-1} for a debit card for each week in a historical period (e.g., November 2020 to April 2023). Each data point 402₀, 402₁, . . . 402_{N-1} relates to a 10-week period. The set of features for the data point relate to events and data in the first eight weeks of the 10-week period, and the determination of whether there was a positive outcome, or a negative outcome is based on the events and data in the last week of the 10-week period. It can be seen that in this example multiple data points comprise features that relate to the same week. In other words, the 10-week periods of the data points are overlapping.

The data points received at the data ingestor 202 are subdivided into at least two non-overlapping datasets—a first training dataset 216 and a second training dataset 218 (which may also be referred to as the first validation dataset). The first training dataset 216 is used to train a primary prediction model 220 and the second training dataset 218 is used to train a secondary prediction model 222. In some cases, as described in more detail below, the second dataset may also be used to fine-tune the primary prediction model 220 (in such cases the second training dataset may be referred to as the first validation dataset).

As will be described in more detail below, in some cases, the data points received at the data ingestor 202 may be subdivided into more than two datasets. For example, in some cases, in addition to having a first training dataset 216 and a second training dataset 218 (e.g., first evaluation dataset) there may also be an validation dataset 224 (which may also be referred to as the second validation dataset) which may be used to fine-tune the secondary prediction model 222 and/or a test dataset 226 which is used to assess the performance of the multi-stage rare event prediction system 212 comprising the trained primary prediction model 208 and the trained secondary prediction model 210.

In some cases, the data points 214 received at the data ingestor 202 may have already been divided or split into datasets 216, 218, 224, 226. In other words, in some cases the data points may be pre-split into datasets 216, 218, 224, 226 by, for example, the EDPP 120. For example, the data ingestor 202 may receive, in addition to the data points, information indicating which dataset 216, 218, 224, 226 each data point 214 belongs to. In such cases, the data ingestor 202 may be configured to store the information indicating which dataset each data point 214 belongs to in the data repository 204. In other cases, the data points may not be pre-split into datasets. In these cases, the training pipeline 206 may comprise a splitting module 228 which is configured to subdivide the received data points in two or more non-overlapping datasets. There are many known ways to split a set of data points into a plurality of datasets which can be used for training, and optionally fine-tuning and/or evaluating a machine learning system. Preferably the data points are split between the datasets such that each dataset has roughly the same percentage of data points with positive outcomes. Typically training datasets are larger that validation datasets, which are larger than test datasets.

The training pipeline 206 is configured to generated trained primary and secondary prediction models 208, 210 for use in the multi-stage rare event prediction system 212. The training pipeline 206 comprises a first training module 230, a modified dataset generator 232, and a second training module 234. As described above, in some cases, the training pipeline 206 may also comprise a splitting module 228. As described in more detail below, the training pipeline 206 may also comprise an evaluation module 236.

The first training module 230 is configured to train, using the first training dataset 216, a primary prediction model 220 to predict the probably of the rare event occurring from a set of features. The primary prediction model is a prediction model with a machine learning algorithm or component. In some cases, the primary prediction model may be an XGBoost model. The output of the first training module 230 is the trained primary prediction model 208.

A prediction model, such as the primary prediction model 220, with a machine learning algorithm or component, comprises parameters (e.g., weights and biases) that control how the output (e.g., prediction score) of the prediction model is generated from a set of inputs (e.g., set of features). In other words, a model parameter is internal to the prediction model. The goal of training a prediction model is to adjust the parameters of the prediction model so that the prediction model generates the correct output (or as close to the correct output as possible) for each data point in the training dataset. Training is generally an iterative process in which the prediction model is used to generate an output (e.g., a prediction score) for the set of features of each data point, the output of the prediction model (e.g., prediction score) for each data point is then compared to the actual output (i.e., whether the particular event occurred or not) for that data point to determine an error therebetween, and the parameters are adjusted to reduce the error. There are many known methods and algorithms for training a machine learning model using a training dataset (i.e., a labelled dataset). The first training module 230 may be configured to use any suitable training technique or algorithm to train the primary prediction model using the training dataset.

One example algorithm that may be used to train a machine learning model is called gradient descent. Gradient descent is an algorithm which is designed to minimize a loss function or a cost function which represents the error between the output of the prediction model and the actual output (i.e., the error between the predicted output and the actual output). To do this it uses a direction and a learning rate. The learning rate is the size of the steps (i.e., changes) to the parameters to reach the minimum cost function or loss function. As noted above, the cost/loss function measures the difference, or error, between the actual output and the output of the prediction model. It is an iterative process. Wherein in each iteration the derivative of cost function or loss function is determined for each parameter by, for example, backpropagation. This provides the direction of steepest descent for a parameter and the parameter is adjusted in that direction. This is repeated until the cost function or loss function is minimized (e.g., it is no longer decreasing). It is noted that a loss function generally refers to the error of one training data point where a cost function calculates the average error across all the data points in a training dataset. However, these terms are often used interchangeably.

In some cases, first training module 230 may also be configured to fine-tune the primary prediction model 220 using another labelled dataset (e.g., the second training dataset 218 (which may also be referred to as the first validation dataset)). As described above, training a prediction model comprises adjusting the parameters of the prediction module to achieve a certain goal (e.g., predict a rare event). In contrast, fine-tuning a prediction model generally comprises adjusting the prediction model's higher level hyper parameters. A hyper parameter is a parameter that is external to the prediction model. Hyper parameters include, but are not limited to, parameters that control the learning or training process. Example hyper parameters include the learning rate for training a neural network, and the C and sigma parameters for support vector machines. Fine tuning a model involves evaluating the performance of the model in response to new inputs thus it is desirable that the other dataset (e.g., the first evaluation dataset/second training dataset 218) include data points that the model has not seen before (e.g., data points that are not in the first training dataset 216).

When the first training module 230 is configured to train and fine-tune the primary prediction model, the first training module 230 may be configured to generate multiple trained primary prediction models using the first training dataset 216, each of which is generated using different hyper parameters. For example, the first training module 230 may be configured to generate a plurality of trained primary predication models using the first training dataset 216, wherein each of the trained primary prediction models is generated using a different learning rate. The first training module 230 may then select the trained primary prediction model that performs the best, according to one or more metrics, with respect to the data points in the second training dataset 218 as the final trained primary prediction model. This may comprise, for each trained primary prediction model, using that trained primary prediction model to generate a prediction score for each data point in the second training dataset 218; and generating one or more model metrics for that trained primary prediction model based on the generated prediction scores. One of the trained primary prediction models may then be selected as the final trained primary prediction model based on the one or more model metrics.

Model metrics that can be used to assess a model's performance vary based on the type of model. Example metrics which can be used to assess a classification model's performance, with respect to a labelled dataset include, but are not limited to, accuracy, precision, recall, and area under the ROC (receiver operating characteristics) curve (AUC-ROC). Accuracy measures how often a model correctly predicts the output. Accuracy is calculated as the number of correct predictions divided by the total number of predictions as shown in equation (1) where TP is the number of true positives, TN is the number of true negatives, FP is the number of false negatives, and FN is the number of false negatives. Precision measures how often the model makes correct positive predictions. Precision can be calculated by dividing the number of correct positive predictions (true positives) by the total number of instances the model predicted as positive (both true and false positives) as shown in equation (2). Recall, which may also be referred to as sensitivity or the true positive rate (TPR), measures how often a model identifies positive instances from the actual positive samples in the dataset. Recall can be calculated by dividing the number of true positives by the number of positive instances (true positives+false negatives) as shown in equation (3).

$$Accuracy = \frac{Correct predicions}{All predictions} = \frac{T P + T N}{T P + T N + F P + F N} \qquad ( 1 )$$

$$Precision = \frac{T P}{T P + F P} \qquad ( 2 )$$

$$Recall = \frac{T P}{T P + F N} \qquad ( 3 )$$

An ROC curve is a graph showing the performance of a classification model at all classification thresholds. The curve plots the true positive rate (TPR) (which is also called the Recall) as shown in equation (3) vs the false positive rate (FPR) as shown in equation (4) at different classification thresholds. A classifier model generally outputs a prediction value that indicates the probability that an input/item falls within a class. A classification threshold specifies the minimum prediction value for an input/item to be classified as positive (i.e., as falling in the class). Accordingly, lowering the classification threshold classifies more items as positive thus increasing both false positives and true positives. AUC measures the area underneath the ROC curve from (0,0) to (1,1). AUC-ROC thus provides an aggregate measure of performance across all possible classification thresholds and represents that the model rates a random positive example more highly than a random negative example. It is noted that these metrics are different from the cost function, or the loss function used during training.

$$F P R = \frac{F P}{F P + T N} \qquad ( 4 )$$

Accuracy alone is generally not a good metric for evaluating the performance of a prediction model that is trained on an imbalanced dataset where there is a significant difference between the number of data points in the dataset that have a positive outcome and the number of data points in the dataset with a negative outcome, particularly when the underrepresented outcome is the more important outcome to correctly predict. This is because even if the prediction model incorrectly predicted all of the data points in the evaluation dataset with the underrepresented outcome, the prediction model may still have high accuracy. For example, consider a dataset with 95 data points with negative outcomes and 5 data points with positive outcomes, if the model classifies all inputs as negative it will still have a.95 accuracy score.

Accordingly, metrics such as precision, recall and AUC-ROC may be more suitable for evaluating the perform of a predication model that is based on an imbalanced dataset. Where it is more important to detect all of the positive outcomes, even at the cost of having more false positives, then the recall metric may be used to evaluate the performance of a trained model. Therefore, in some examples, the first training module 230 may be configured to select the trained primary prediction model that has the best recall (i.e., the highest recall). In some cases, to encourage the trained primary prediction model to focus on being correct when it outputs a high or a relatively high prediction score, the first training module 230 may be configured to select the trained primary prediction model that has the best recall (i.e., the highest recall) for the k datapoints with the highest prediction scores, which is referred to the recall at k metric (or recall @k).

The modified dataset generator 232 is configured to, once a final trained primary prediction model 208 has been generated by the first training module 230, generate a modified second training dataset 238 (e.g., a modified first evaluation dataset) using the output of the trained primary prediction module for each of the data points in the second training dataset 218. Specifically, in some examples, the modified dataset generator 232 is configured to use the trained primary prediction model 208 to generate a primary prediction score for each data point in the second training dataset 218. The modified dataset generator 232 may then select the k data points in the second training dataset 218 with the highest primary prediction scores and add the selected data points to the modified second training dataset 238. In other words, the modified second training dataset comprises the k data points in the second training dataset 218 with the highest primary prediction scores. k may be any suitable integer. In one example, k may be 250. The modified dataset generator 232 may also augment each data point in the modified second training dataset 238 with its corresponding primary prediction score. In other words, the primary prediction score for a data point in the modified second training dataset 238 may be added thereto as an additional feature.

The second training module 234 is configured to train the secondary prediction model 222 using the modified second training dataset 238 to generate the trained secondary prediction model 210. The secondary prediction model, like the primary prediction model, is a prediction model with a machine learning algorithm or component. In some cases, the secondary prediction model may be an XGBoost model. The second training module 234 may be configured to train the secondary prediction model using the modified second training dataset 238 via any suitable method, technique or algorithm, such as, but not limited to, those described above with respect to the first training module 230.

In some cases, the second training module 234 may also be configured to fine-tune the secondary prediction model 222 using yet another labelled dataset (e.g., the validation dataset 224, which may also be referred to as the second validation dataset). Preferably the validation dataset 224 has different data points from the first and second training datasets. In other words, preferably none of the data points in the first and second training datasets 216, 218 are in the validation dataset 224 and vice versa. As described above, fine-tuning a prediction model generally comprises adjusting the prediction model's higher level hyper parameters, such as the learning rate. In some cases, the second training module 234, like the first training module 230 may be configured select one or more of the hyper parameters that produces the trained secondary prediction model with the best performance, based on one or more model metrics, with respect to the data points in the validation dataset 224. The trained secondary prediction model resulting from those hyper parameters may then be selected as the final trained secondary prediction model 210.

When the second training module 234 is configured to train and fine-tune the secondary prediction model, the second training module 234 may be configured to generate multiple trained secondary prediction models using the modified second training dataset 238, each of which is generated using different hyper parameters (e.g., different learning rates). The second training module 234 may then select the trained secondary prediction model that performs the best, according to one or more model metrics, with respect to the data points in the validation dataset 224 as the final trained primary prediction model. This may comprise, for each trained secondary prediction model: using the final trained primary prediction model 208 to generate a primary prediction score for each data point in the validation dataset 224; using the trained secondary prediction model under test to generate a secondary score for each data point in the validation dataset 224 in combination with the primary prediction score generated by the trained primary prediction model 208 for that data point; and then generating one or more model metrics for the trained secondary prediction model under test based on the secondary prediction scores. One of the trained secondary prediction models may then be selected as the final trained secondary prediction model 210 based on the one or more model metrics.

Any suitable model metric or set of model metrics may be used to assess the performance of a trained secondary prediction model with respect to a labelled dataset (e.g., the validation dataset). For example, any of the model metrics described above with respect to the first training module 230 (e.g., accuracy, performance, recall, AUC-ROC) may be used to assess trained secondary prediction models. In some examples, a different metric or set of metrics may be used to fine-tune the secondary prediction model than the metric or set of metrics used to fine-tune the primary prediction model. For example, where the recall metric or recall at k metric may be used to fine-tune the primary prediction model, the AUC-ROC metric, the precision metric or the precision at k metric may be used to fine-tune the secondary prediction model (e.g., used to select a set of hyper parameters and a trained secondary prediction model generated thereby). Specifically, a trained secondary prediction model may be selected that optimizes the AUC-ROC metric, the precision metric, or the precision at k metric (i.e., precision calculated from the top k results).

Once both the trained primary prediction model 208 and the trained secondary prediction model 210 have been generated, the trained primary and secondary prediction models 208, 210 can be used to form a multi-stage rare event prediction system 212 to predict the probability of the rare event occurring. For example, as shown in FIG. 2, the trained primary prediction model 208 can form a first phase of the multi-stage rare event prediction system 212 which is configured to receive a set of features and generate a primary prediction score for the rare event based thereon, and the trained secondary prediction model 210 is configured to receive the set of features in combination with the primary prediction score and generate a secondary/final prediction score for the rare event based thereon.

In some cases, the training pipeline 206 may also have an evaluation module 236 which is configured to evaluate the performance of the multi-stage rare event prediction system 212 in response to new data. Accordingly, the evaluation model 236 is configured to assess the performance of the multi-stage rare event prediction system 212 in response to yet another dataset, which may be referred to as the test dataset 226. To see how the multi-stage rare event prediction system 212 responds to new data, the test dataset 226 preferably comprises a different set of data points from those used in training and re-tuning the primary and secondary prediction models. The reason for using a test dataset, instead of the validation dataset(s), is that the validation dataset affects the model training process, hence, using the validation dataset might lead to the same biased assessment as using the training dataset(s).

The evaluation module 236 is configured to, for each data point in the test dataset 226, use the trained primary prediction model 208 to generate a primary prediction score for the rare event based on the set of features in the data point, and use the trained secondary prediction model 210 to generate a secondary/final prediction score for the rare event based on the set of features in the data point in combination with the corresponding primary prediction score. The evaluation model 236 may then evaluate the performance of the multi-stage rare event prediction system 212 by generating one or more model metrices from the final prediction scores for the data points in the test dataset 226 and the actual outcomes for the data points in the test dataset 226. Any suitable model metric or set of model metrics may be used to evaluate the performance of the multi-stage rare event prediction system. For example, any combination of the metrics (e.g., accuracy, AUC-ROC, precision, recall, precision @k (precision based on the top k results), recall @k (recall based on the top k results)) may be used to assess the performance. Another example model metric that may be used to assess the performance of the is the FP/TP rate which is shown in equation (5). Alternatively, an FP/TP rate @k can be used which is the FP/TP rate based on the top k results.

$$FP / TP\_Rate = \frac{F P}{T P} \qquad ( 5 )$$

Table 1 illustrates an example set of performance metrics for an example multi-stage rare event prediction system 212 that has been trained to predict whether a debit card fraud transaction will occur based on data points described above with respect to FIGS. 3 and 4 with the example feature sets described above wherein k=250.

TABLE 1

| | Precision @ k | | Recall @ k | | FP/TP @ k | |
|---|---|---|---|---|---|---|
| | OOS | OOT | OOS | OOT | OOS | OOT |
| January | 0.0552 | 0.0493 | 0.0088 | 0.0018 | 17/1 | 19/1 |
| 2024 | | | | | | |
| March | 0.07 | 0.1438 | 0.012 | 0.004 | 13.2/1 | 5.95/1 |
| 2024 | | | | | | |
| Threshold | | 0.2 | | | | 4/1 |

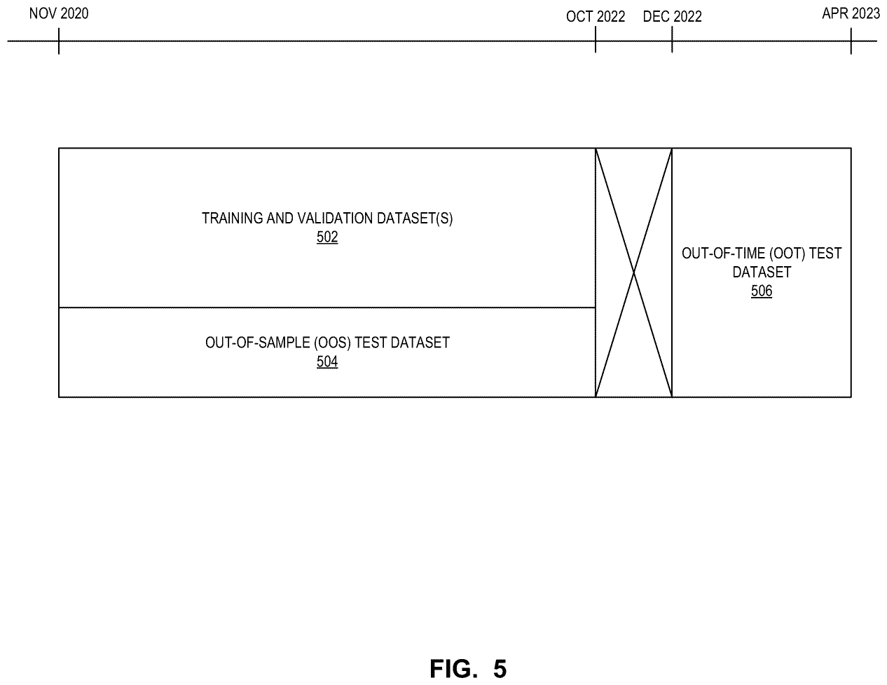

In the example of Table 1 the test dataset 226 which was used to evaluate the multi-stage rare event prediction system 212 was sub-divided into an out of sample (OOS) dataset which comprised data points in the same time frame as the data points in the datasets used to train the primary and secondary prediction models, and an out of time (OOT) dataset which comprised data point in a different time frame from the data points in the datasets used to train the primary and secondary prediction models. For example, as shown in FIG. 5, if the data points relate to the time period between November 2020 and April 2023, then the training dataset(s) 502 may comprise data points in a first time period (e.g., the time period from November 2020 to October 2022). In this example, the OOS test dataset 504 also comprises data points in the first time period, but different data points from those in the training data set(s) 502. In one example, the training dataset(s) may comprise 80% of the data points in the first time period and the OOS test dataset 504 may comprise 20% of the data points in the first time period. In contrast the OOT test dataset 506 comprises data points in a second, subsequent, time period (e.g., the time period between December 2022 and April 2023). It will be appreciated that validating a model (or system) on the latest unseen data, such as the OOT test dataset 506 described above, is known as out-of-time testing. Out-of-time testing can be used to verify model stability and verify that there is no performance dip that occurs on data in a new time period.

The evaluation module 236 may provide the one or more model metrics generated from the output of the multi-stage rare event prediction system 212 in response to the test dataset 226 to a user, via, for example, a user interface (UI) 240 for evaluation. In some cases, the one or more model metrics is/are provided to a client device 190 that connects over a data communication link 242 to the user interface 240. For example, a user may receive the one or more model metrics generated by the evaluation module 236 via a web browser 244 or some other application that operates on the client device 190. The user may then analyze the one or more model metrics to determine if the multi-stage rare event prediction system 212 satisfies a performance goal. If the user determines, from the one or more model metrics, that the multi-stage rare event prediction system 212 does not meet desired a performance goal then the user may make changes to the data points and or the models—e.g., adjust the features in a data point, the length of the feature window and/or target window, or the models that are trained, etc.—and start the training process over again. If, however, the user determines, from the one or more model metrics, that the multi-stage rare event prediction system 212 does meet the desired performance goal then the multi-stage rare event prediction system 212 may then be used to generate predictions for real-live data.

Specifically, once the multi-stage rare event prediction system 212 has been formed (and, optionally validated by the evaluation module 236) it may be used to generate a prediction score that indicates the likelihood that rare event will occur in the target window (e.g., in the next week) based on a new (e.g., live) set of features. Specifically, the multi-stage rare event prediction system 212 may receive, at, for example, a feature interface 246 thereof, a new (e.g., live) set of features that represent historical events and data in the feature window. In some cases, the set of features may be received by the data ingestor 202 and provided to the feature interface 246. In these cases, the relevant historical events and data may be stored in the source database system 110 (e.g., the transaction events for a particular debit card that fall within a target window) and the EDPP 120 may be configured to retrieve the relevant historical events and data from the source database system 110 and generate a set of features that represent the relevant historical events and data. The EDPP 120 may then provide the generated set of features to the cloud-based computing cluster 130 via, for example, the data ingestor 202. The data ingestor 202 may then provide the received set of features to the feature interface 246.

Once the feature interface 246 has received a set of features representing a set of historical events and data, the feature interface 246 uses the trained primary prediction model 208 to generate a primary prediction score that indicates, based on the received set of features, the likelihood that the rare event will occur. Once the primary prediction score has been generated the feature interface 246 uses the trained secondary prediction model 210 to generate a secondary prediction score that indicates, based on the combination of the received set of features and the primary prediction score, the likelihood that the rare event will occur. The secondary prediction score may then be output to a user, e.g., via the user interface 240, and the user may determine whether any action is to be taken.

For example, in some cases, action may be taken if the prediction score is above a predetermined threshold. The threshold and the action that may be taken may be based on the rare event that is being predicted. For example, if the rare event that is being predicted is a debit card fraud transaction, then if the prediction score exceeds a certain threshold indicating that it is very likely there will be a fraudulent transaction associated with the debit card, then the user (e.g., bank employee) may proactively initiate the cancellation and re-issuance of the debit card. In other cases, instead of the secondary prediction score being output to a user who manually reviews the second prediction scores, the secondary prediction score may be provided to a system which may (i) automatically determine whether the prediction score is above a certain threshold and only forward those prediction scores along with related information to the user; and/or (ii) automatically take action if the secondary prediction score is above a certain threshold.

It will be appreciated that, while in the example shown in FIG. 2 the multi-stage rare event prediction system 212 only comprises one trained secondary prediction model 210, in other example there may be multiple trained secondary prediction models each of which is configured to receive, in addition to the original set of features, the prediction score generated by the previous stage. Each subsequent secondary prediction model may be trained in a similar manner as the secondary prediction model 222. Increasing the number of secondary prediction models in the multi-stage rare event prediction system 212 may increase the performance of the multi-stage rare event prediction system. However, this may come at the expense of a more complicated rate event prediction system that takes more time to train and fine-tune. Furthermore, additional secondary prediction modules may also spread out the available training data points across more datasets making each dataset smaller.

It will be appreciated that, while the components shown in FIG. 2 for the cloud-based computing cluster 130 can be implemented within the system 100 in FIG. 1, in other cases, the components shown in FIG. 2 are instead implemented in an isolated computing system. In other words, the components shown in FIG. 2 can be implemented as a computing system without the EDPP 120 and the source database system 110.

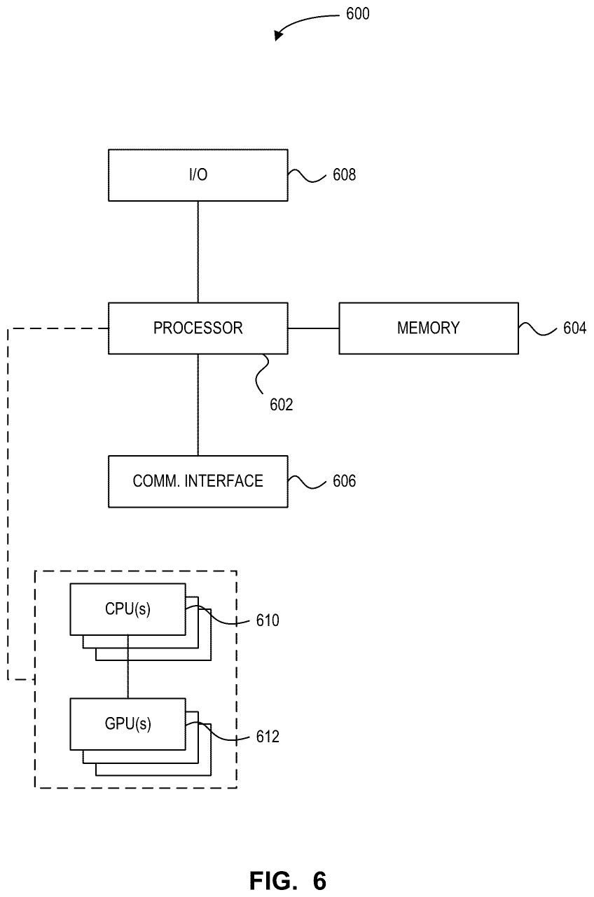

Reference is now made to FIG. 6 which illustrates a simplified block diagram of an example computer 600. Computer 600 is an example implementation of a computer which may implement the source database system 110, the EDPP 120, and/or one or more components of the cloud-based computing cluster 130 of FIGS. 1 and 2. Computer 600 has at least one processor 602 operatively coupled to at least one memory 604, at least one communications interface 606 (also referred to herein as a network interface), and at least one input/output (I/O) device 608.

The at least one memory 604 includes a volatile memory that stores instructions executed or executable by the processor 602, and input and output data used or generated during execution of the instructions. The memory 604 may also include non-volatile memory used to store input and/or output data—e.g., within a database—along with program code containing executable instructions.

The processor 602 may transmit or receive data via the communications interface 606 and may also transmit or receive data via any additional input/output device 608 as appropriate.

In some cases, the processor 602 includes a system of central processing units (CPUs) 610. In other cases, the processor 602 includes a system of one or more CPUs 310 and one or more Graphical Processing Units (GPUs) 612 that are coupled together. For example, the trained primary prediction model and/or the trained secondary prediction model may execute machine learning computations on CPU and GPU hardware, such as the system of CPUs 610 and GPUs 612 of FIG. 6.

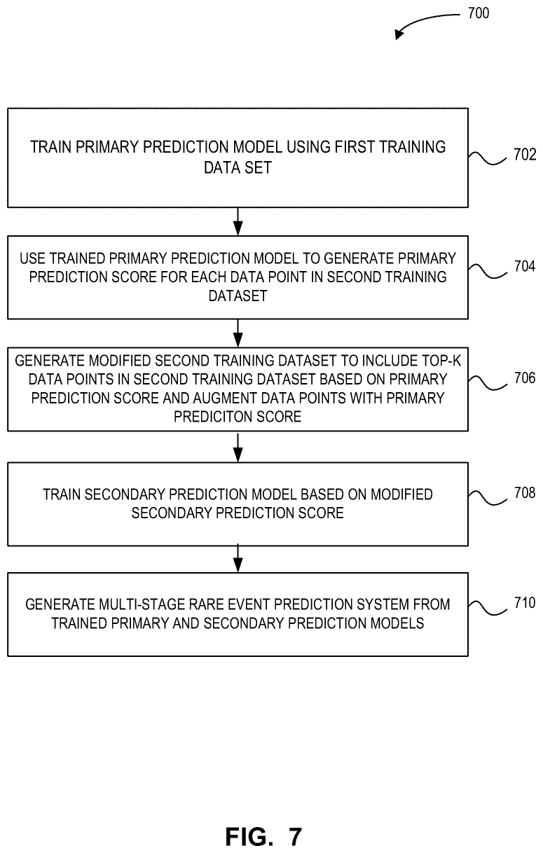

Reference is now made to FIG. 7 which illustrates an example method 700 of generating a multi-stage rare event prediction system, which may be implemented, for example, by the training pipeline 206 of FIG. 2. The method 700 begins at block 702 where a primary prediction model (e.g., primary prediction model 220) is trained (i.e., parameters selected therefor) using a first training dataset (e.g., first training dataset 216) to generate a trained primary prediction model (e.g., trained primary prediction model 208). The primary prediction model is designed to receive a set of features representing a set of historical events and data (e.g., historical events and data in a feature window) and generate, based on the set of features, a prediction score that indicates the likelihood that a rare event will occur subsequent the historical events (e.g., in a target window after the feature window).

The first training dataset comprises a plurality of data points each of which comprise a set of features that represent a set of historical events and data (e.g., historical events and data in the feature window) and an indication of whether the rare event occurred subsequent the historical events (e.g., in the target window). A data point in which the rare event occurred in the target window is said to have a positive outcome, and a data point in which the rare event did not occur in the target window is said to have a negative outcome. The first training dataset is thus a labelled dataset. In the examples described herein, the first training dataset is an imbalanced dataset. Specifically, the first training dataset comprises significantly more data points in which the rare event did not occur (i.e., data points with a negative outcome) than data points in which the rare event did occur (i.e., data points with a positive outcome). Any known method, such as, but not limited to, those described above with respect to the first training module 230, may be used to train the primary prediction model using the first training dataset.

In some cases, block 702 may also comprise fine-tuning the primary prediction model (e.g., primary prediction model 220) using a second, different, dataset (e.g., the second training dataset 218). The second training dataset, like the first training dataset, comprises a plurality of data points each of which comprise a set of features that represent a set of historical events and data (e.g., historical events and data in the feature window) and indication of whether the rare event occurred subsequent the historical events (e.g., in the target window). Preferably the second training dataset (e.g., the second training dataset 218) may comprise different data points from the first training dataset 216. The primary prediction model may be fine-tuned using the second training dataset using any known method, such as, but not limited to, those described above with respect to the first training module 230. For example, the primary prediction model may be fine-tuned so as to optimize one or more model metrics, such as, but not limited to the recall metric or the recall @k metric.

Once a trained primary prediction model has been generated (and, optionally, fine-tuned) the method 700 proceeds to block 704.

At block 704, the trained primary prediction model is used to generate a primary prediction score for each data point in a second training dataset (e.g., second training dataset 218). The second training dataset, like the first training dataset, comprises a plurality of data points each of which comprise a set of features that represent a set of historical events and data (e.g., historical events and data in the feature window) and indication of whether the rare event occurred subsequent the historical events (e.g., in the target window). Accordingly, the second training dataset, like the first training dataset is a labelled dataset. Preferably the second training dataset (e.g., the second training dataset 218) comprises different data points from the first training dataset 216. In some cases, where fine-tuning was performed on the primary prediction model, the same dataset that is used to fine-tune the primary prediction model may be used in block 704. Once a primary prediction score has been generated for each data point in the second training dataset, the method 700 proceed to block 706.

At block 706, a modified second training dataset is generated from the trained primary prediction model. Specifically, the modified second training dataset is generated by adding k data points of the second training dataset with the highest primary prediction score to the modified second training dataset and adding the corresponding primary prediction score to each of the k data points of the modified second training dataset as a feature, wherein k is an integer greater than one. In one example, k is equal to 250. However, this is just an example and in other examples k may be another integer. Generating the modified second training dataset may comprise ranking the data points in the second training dataset based on the primary prediction scores generated in block 704; selecting the top k data points in the ranked list to form the modified second training dataset; and adding the primary prediction score generated in block 704 for each data point in the modified second training dataset to that data point as a feature. Once the modified training dataset has been generated, the method 700 proceeds to block 708.

At block 708, a second prediction model (e.g., secondary prediction model 222) is trained (i.e., parameters selected therefor) using the modified second training dataset (e.g., modified second training dataset 238) to generate a trained secondary prediction model (e.g., trained secondary prediction model 210). The secondary prediction model is designed to receive a set of features representing a set of historical events and data (e.g., historical events and data in a feature window) and a primary prediction score generated by the trained primary prediction model as another feature and generate, based on the set of features and the primary prediction score, a prediction score that indicates the likelihood that the rare event will occur subsequent the historical events (e.g., in a target window after the feature window). Any known method, such as, but not limited to, those described above with respect to the first training module 230 and the second training module 234, may be used to train the second prediction model using the modified second training dataset.

In some cases, block 708 may also comprise fine-tuning the secondary prediction model (e.g., primary prediction model 220) using yet another different, dataset (e.g., the validation dataset 224). The validation dataset, like the first and second training datasets, comprises a plurality of data points each of which comprise a set of features that represent a set of historical events and data (e.g., historical events and data in the feature window) and indication of whether the rare event occurred subsequent the historical events (e.g., in the target window). Preferably the validation data set (e.g., the second training dataset 218) may comprise different data points from the first and second training datasets. The secondary prediction model may be fine-tuned using the validation dataset using any known method, such as, but not limited to, those described above with respect to the first training module 230 and/or the second training module 234. For example, the secondary prediction model may be fine-tuned so as to optimize one or more model metrics, such as, but not limited to, the precision metric, the precision @k metric, the AUC-ROC metric etc.

Once a trained secondary prediction model has been generated (and, optionally, fine-tuned) the method 700 proceeds to block 710.

At block 710, a multi-stage rare event prediction system is formed from the trained primary prediction model and the trained secondary prediction model to predict, from a set of features representing a set of historical events and data, the probability or likelihood of the rare event occurring. As shown in FIG. 2, the trained primary prediction model may form a first phase of the system which is configured to receive a set of features and generate a primary prediction score for the rare event based thereon, and the trained secondary prediction model may form a second phase that is configured to receive the set of features in combination with the primary prediction score and generate a secondary (final) prediction score for the rare event based thereon. Once the multi-stage rare event prediction has been formed, the method 700 may end.

In some cases, the method 700 may also comprise validating the generated multi-stage rare event prediction system using a test dataset. The test dataset, like the training and validation datasets, comprises a plurality of data points each of which comprise a set of features that represent a set of historical events and data (e.g., historical events and data in the feature window) and indication of whether the rare event occurred subsequent the historical events (e.g., in the target window). As described above, validating the multi-stage rare event prediction system using a test dataset may comprise using the multi-stage rare event prediction system to generate a prediction score for each datapoint in the test dataset; generating one or more model metrics based on the generated prediction scores and the actual outcomes for the data points; and determining, based on the one or more model metrics, whether the multi-stage rare event prediction system meets a performance goal. Any suitable model metric or set of metrics, such as those described above with respect to the evaluation module 236 may be used to assess the performance of the multi-stage event prediction system. As described above, in some cases, the test dataset may comprise out-of-sample data points (i.e., data points that are, different to, but in the same time window or time period as the training datasets and validation datasets), out-of-time data points (i.e., data points that are in a different time window or time period from the training datasets and the validation datasets), or both out-of-sample and out-of-time data points.

In the example method 700 of FIG. 7 the multi-stage rare event prediction system comprises only two stages—a primary prediction model stage followed by a secondary prediction model stage, however, in other examples the multi-stage rare event prediction model may comprise more than two stages—a primary prediction model stage followed by multiple secondary prediction model stages. In such cases, blocks similar to blocks 704, 706 and 708 of the method of FIG. 7 may be executed for each secondary prediction model stage. Specifically, for each secondary prediction model stage, the trained prediction model in the previous stage is used to generate a prediction score for each data point in a training dataset for that secondary prediction model; a modified training dataset for that secondary prediction model is generated by selecting the k data points in the training dataset for that second prediction model with the highest prediction score to form the modified training dataset for that secondary prediction model and augmenting each data point in the modified training dataset with the prediction score generated by the trained prediction model in the previous stage; and the secondary prediction model is trained using the modified training dataset.

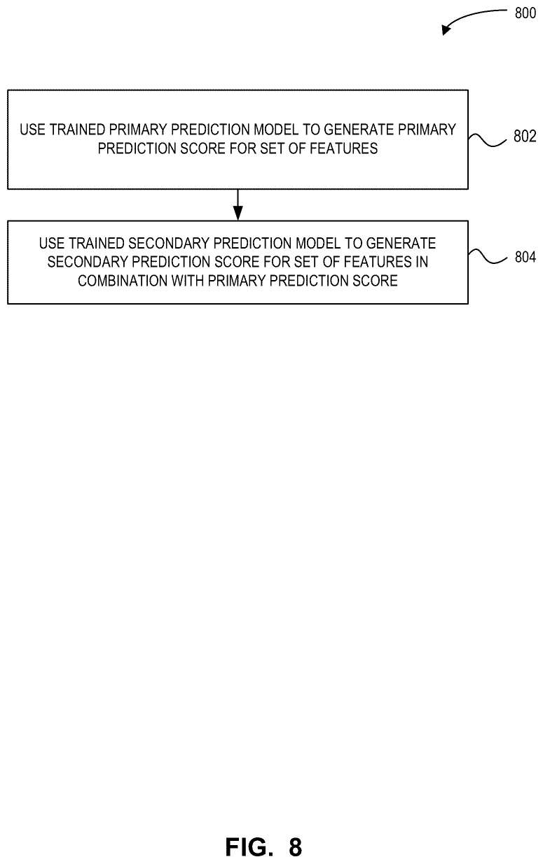

Reference is now made to FIG. 8 which illustrates an example method 800 of using a multi-stage rare event prediction system generated in accordance with the method 700 of FIG. 7 to generate a prediction score for a rare event for a set of features representing a set of historical events and data. The method 800 begins at block 802 where the trained primary model is used to generate a prediction score for the set of features representing the set of historical events and data. The method 800 then proceeds to block 804 where the trained secondary prediction model is used to generate a secondary prediction score for the set of features in combination with the primary prediction score. In other words, the secondary prediction model receives as inputs the original set of features and the primary prediction score generated by the trained primary prediction model. The secondary prediction score may then be used as the final prediction score.

In the example method 800 of FIG. 8 the multi-stage rare event prediction system comprises only two stages—a primary prediction model stage followed by a secondary prediction model stage, however, in other examples the multi-stage rare event prediction model may comprise more than two stages—a primary prediction model stage followed by multiple secondary prediction model stages. In such cases, a block similar to block 804 may be executed for each secondary prediction model stage. Specifically, for each secondary prediction model stage the trained secondary prediction model in that stage is used to generate a secondary prediction score for the set of features in combination with the prediction score generated by the trained prediction model in the previous stage. The secondary prediction score generated by the final stage may then be used as the final prediction score for the set of features.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems

and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A system for performing rare event prediction, the system comprising:
a memory, a communication interface, and at least one processor operatively coupled to the memory and the communication interface;
the at least one processor configured to:
train a primary prediction model using a first training dataset to generate a trained primary prediction model;
use the trained primary prediction model to generate a primary prediction score for a rare event for each data point in a second training dataset;
generate a modified second training dataset by selecting k data points of the second training dataset with a highest primary prediction score to form the modified second training dataset and adding the corresponding primary prediction score to each of the k data points of the modified second training dataset as a feature, wherein k is an integer greater than one;
train a secondary prediction model using the modified second training dataset to generate a trained secondary prediction model; and
form a multi-stage rare event prediction system from the trained primary prediction model and the trained secondary prediction model.

2. The system of claim 1, wherein the at least one processor is configured to, prior to using the trained primary prediction model to generate the primary prediction score for each data point in the second training dataset, fine-tune the trained primary prediction model using the second training dataset.

3. The system of claim 2, wherein the at least one processor is configured to fine-tune the trained primary prediction model so that the trained primary prediction model has an optimized recall metric with respect to the second training dataset.

4. The system of claim 2, wherein the at least one processor is configured to fine-tune the trained primary prediction model so that the trained primary prediction model has an optimized recall at k metric with respect to the second training dataset.

5. The system of claim 1, wherein the at least one processor is configured to, prior forming the multi-stage rare event prediction system:
use the trained primary prediction model to generate a primary prediction score for the rare event for each data point in a validation dataset; and
fine-tune the trained secondary prediction model using the validation dataset and the primary prediction scores for the data points in the validation dataset.

6. The system of claim 1, wherein the at least one processor is configured to fine-tune the trained secondary prediction model so that the trained secondary predication model has an optimized area under a receiver operating characteristics curve metric and/or a precision at k metric.

7. The system of claim 1, wherein the at least one processor is configured to:
use the trained primary prediction model to generate a primary prediction score for the rare event for each data point in a test dataset;
use the trained secondary prediction model to generate a secondary prediction score for the rare event for each data point in the test dataset in combination with the corresponding primary prediction score; and
evaluate a performance of the multi-stage rare even prediction system based on the secondary prediction scores.

8. The system of claim 1, wherein each data point comprises a set of features representing a set of events in a first time period and an indication of whether the rare event occurred during a second, subsequent, time period.

9. The system of claim 8, wherein there is a time buffer between the first time period and the second, subsequent, time period.

10. The system of claim 1, wherein the multi-stage rare event prediction system is configured to: receive a set of features representing a set of historical events and use the primary trained prediction model to generate a primary prediction score for the set of features; and use the trained secondary prediction model to generate a secondary prediction score for the set of features in combination with the primary prediction score.

11. The system of claim 10, wherein the at least one processor is configured to use the multi-stage rare event prediction system to generate a prediction score for the rare event for a new set of features representing a new set of historical events.

12. The system of claim 11, wherein the at least one processor is configured to compare the prediction score for the rare event for the new set of features to a predetermined threshold, and in response to determining the prediction score exceeds the predetermined threshold, take an action.

13. The system of claim 1, wherein the at least processor is configured to:
use the trained primary prediction model to generate a primary prediction score for the rare event for each data point in a third training dataset;
use the training secondary prediction model to generate a secondary prediction score for the rare event for each data point in the third training dataset in combination with the corresponding primary prediction score;
generate a modified third training dataset by selecting k data points of the third training dataset with a highest primary prediction score to form the modified third training dataset and adding the corresponding secondary prediction score to each of the k data points of the modified third training dataset as a feature; and
train a tertiary prediction model using the modified third training dataset to generate a trained tertiary prediction model;
wherein the multi-stage rare event prediction system is also formed from the trained tertiary prediction model.

14. The system of claim 1, wherein the primary prediction model is an XGBoost model.

15. A method for performing rare event prediction, the method executed in a computing environment comprising one or more processors, a communication interface, and memory, and the method comprising:
training a primary prediction model using a first training dataset to generate a trained primary prediction model;
using the trained primary prediction model to generate a primary prediction score for a rare event for each data point in a second training dataset;
generating a modified second training dataset by selecting k data points of the second training dataset with a highest primary prediction score to form the modified second training dataset and adding the corresponding primary prediction score to each of the k data points of the modified second training dataset as a feature, wherein k is an integer greater than one;
training a secondary prediction model using the modified second training dataset to generate a trained secondary prediction model; and
forming a multi-stage rare event prediction system from the trained primary prediction model and the trained secondary prediction model.

16. The method of claim 15, further comprising, prior to using the trained primary prediction model to generate the primary prediction score for each data point in the second training dataset, fine-tuning the trained primary prediction model using the second training dataset.

17. The method of claim 15, further comprising, prior forming the multi-stage rare event prediction system:
using the trained primary prediction model to generate a primary prediction score for the rare event for each data point in a validation dataset; and
fine-tuning the trained secondary prediction model using the validation dataset and the primary prediction scores for the data points in the validation dataset.

18. The method of claim 15, wherein each data point comprises a set of features representing a set of events in a first time period and an indication of whether the rare event occurred during a second, subsequent, time period.

19. The method of claim 15, wherein the multi-stage rare event prediction system is configured to: receive a set of features representing a set of historical events and use the primary trained prediction model to generate a primary prediction score for the set of features; and use the trained secondary prediction model to generate a secondary prediction score for the set of features in combination with the primary prediction score.

20. A non-transitory computer readable medium storing computer executable instructions which, when executed by at least one computer processor, cause the at least one computer processor to carry out a method for performing rare event prediction, the method comprising:
training a primary prediction model using a first training dataset to generate a trained primary prediction model;
using the trained primary prediction model to generate a primary prediction score for a rare event for each data point in a second training dataset;
generating a modified second training dataset by selecting k data points of the second training dataset with a highest primary prediction score to form the modified second training dataset and adding the corresponding primary prediction score to each of the k data points of the modified second training dataset as a feature, wherein k is an integer greater than one;
training a secondary prediction model using the modified second training dataset to generate a trained secondary prediction model; and
forming a multi-stage rare event prediction system from the trained primary prediction model and the trained secondary prediction model.
